(19) United States
(12) Patent Application Publication
(10) Pub. No.: US 2024/0026157 A1
(43) Pub. Date: Jan. 25, 2024

(54) LIGNIN-BASED BIOPLASTIC MATERIAL, PROCESSES FOR PREPARING THE SAME AND USES THEREOF

(71) Applicants: UPM-KYMMENE CORPORATION, 00100 Helsinki (FI); GREEN INNOVATION GMBH, 6020 Innsbruck (AT)

(72) Inventors: Giuliano Leonardi, Innsbruck (AT); Suvi Pietarinen, Helsinki (FI); Christian Hubsch, Helsinki (FI)

(21) Appl. No.: 18/257,679

(22) PCT Filed: Dec. 17, 2021
(86) PCT No.: PCT/EP2021/086579

§ 371 Date: Jun. 15, 2023

(30) Foreign Application Priority Data
Dec. 21, 2020 (IT) 102020000031619

(51) Int. Cl. C08L 97/00; C08J 5/18

(52) U.S. Cl. CPC C08L 97/005; C08J 5/18; C08L 2201/06; C08J 2497/00; C08J 2467/04; C08J 2467/02; C08L 2205/02; C08L 2203/16

(57) ABSTRACT

A lignin-based bioplastic material is disclosed including a lignin fraction and at least a biodegradable biopolymer, as well as processes for preparing the same and uses in agriculture. Also disclosed are items for agriculture at least partially made of the lignin-based bioplastic material, such as pots, pipes and mulch films.

### FIELD OF THE INVENTION

The present invention concerns a lignin-based bioplastic material comprising a lignin fraction and at least a biodegradable biopolymer, as well as processes for preparing the same and uses in agriculture.

### STATE OF THE ART

Plastics are widely used in agriculture, but they create challenges for the environment. About 80% of the plastic waste is generated by plastic mulch films. Their waste collection is difficult and significant parts stay in the fields, generating microplastics that end up in rivers and oceans.

Microplastic pollution has recently gained the attention of the public media, politics and research. Microplastics (i.e., plastic particles less than 5 mm in size) have been identified as a global environmental threat for terrestrial and aquatic ecosystems and human health. Agriculture is assumed to be both victim and polluter of microplastic pollution. Agricultural soils receive microplastic immissions from tire wear and fragmented macroplastic that enters the environment through littering. Furthermore, farmers who fertilize their arable land with sewage sludge and compost unintentionally apply the microplastic particles contained in these biosolids. On the other hand, agricultural soils may emit microplastics into aquatic environment. Because of this ambivalent position as both victim and polluter, the information on microplastic pollution is of current interest for agricultural production and might become a relevant topic for agro-environmental policies in the future.

The use of bioplastics, such as biodegradable mulch films, and solutions for accelerating their degradation progress, are therefore highly desirable.

Bioplastics are plastics derived from renewable biomass sources, such as vegetable fats and oils, corn starch, straw, woodchips, or food waste. Bioplastic can be made from agricultural by-products and also from used plastic bottles and other containers using microorganisms. Common plastics, such as fossil-fuel plastics (also called petrobased polymers) are derived from petroleum or natural gas. Not all bioplastics are biodegradable or biodegrade more readily than commodity fossil-fuel derived plastics. As of 2014, bioplastics represented approximately 0.2% of the global polymer market (300 million tons).

Bioplastics are typically used for disposable items, such as packaging, crockery, cutlery, pots, bowls, and straws. Few commercial applications exist for bioplastics. In principle, they could replace many applications for petroleum-derived plastics, however cost and performance remain problematic.

It is therefore felt the need to provide a bioplastic having improved properties of biodegradability and mechanical strength, through a simple and cost-effective production process, so as to preserve the human and animal health, the crop and environment.

### SUMMARY OF THE INVENTION

The above object has been achieved by a lignin-based bioplastic material comprising a lignin fraction and at least a biodegradable biopolymer, as claimed in claim 1.

In another aspect, the present invention relates to a use of said lignin-based bioplastic material in agriculture.

In an additional aspect, the present invention concerns an item for agriculture at least partially made of the lignin-based bioplastic material and having a 2D or 3D shape.

### BRIEF DESCRIPTION OF DRAWINGS

The characteristics and the advantages of the present invention will become clear from the following detailed description, the working examples provided for illustrative and non-limiting purposes, and the annexes Figures wherein:

FIG. 1 shows the thermo-gravimetric analysis of the resin and its mixtures with lignin fraction, as per Example 3,

FIG. 2 shows a mechanical analysis on samples having a thickness of 100 μm for the assessment of (a) Elastic Modulus, (b) Tensile Strength, (c) Elongation at Break, as per Example 3,

FIG. 3 shows a mechanical analysis on samples having a thickness of 200 μm for the assessment of (a) Elastic Modulus, (b) Tensile Strength, (c) Elongation at Break, as per Example 3,

FIG. 4 shows the diffuse reflectance spectrum in the UV-VIS region of the samples of Example 3,

FIG. 5 shows the absorption spectrum in the UV-VIS region of the samples of Example 3,

FIG. 6 shows the aging test results obtained by measuring the elongation at break of the 100 μm thick samples of Example 3, and

FIG. 7 shows the aging test results obtained by measuring the elongation at break of the 200 μm thick samples of Example 3.

### DETAILED DESCRIPTION OF THE INVENTION

The subject of the invention therefore is a lignin-based bioplastic material comprising a lignin fraction and at least a biodegradable biopolymer, wherein:
said lignin fraction comprises fragments having a weight average molecular weight up to 20,000 Daltons, as measured by Size-Exclusion Chromatography, said fragments comprising up to 111 phenylpropane units on weight average, and
said at least a biodegradable biopolymer is selected from polylactic acid (PLA), polyglycolic acid (PGA), poly(lactic-co-glycolic acid) (PLGA), poly(ε-caprolactone) (PCL), poly(butylene succinate) (PBS), poly(γ-glutamic acid) (PGA), polyhydroxyalkanoate (PHA), polyhydroxybutyrate (PHB), poly-3-hydroxyvalerate (PHV), thermoplastic starch (TPS), polybutylene adipate terephthalate (PBAT), starch blend, copolymers and mixtures thereof.

As it will be seen below, the lignin-based bioplastic material achieves a number of unexpected results and advantages. In fact, the lignin fraction is highly effective in promoting plant growth as well as in acting against phytopathogens. Additionally, once in soil, part of the lignin fraction is converted into humic acids, which are known to be growth enhancers and soil conditioners conventionally made from fossil deposits found as brown coal or turf. The presence of the soil enhancer allows to improve the soil arability so that the overall efficacy of the lignin fraction is boosted. This means that a significant amount of renewable carbon in soil is increased, thus inducing better structure of soil and enhancing the growth of plants and beneficial fungi.

However, it has been surprisingly found that once mixed with at least a biodegradable biopolymer, the resulting material is plastically shapeable into items that can find remarkable application especially in agriculture. Therefore, once shaped, the bioplastic material of the invention has a mechanical function, but later it is not only highly biodegradable, but also releases nutrients as a fertilizer and protect against phytopathogens.

The desired shape can be imparted by techniques, such as extrusion, injection moulding, casting, compression moulding, blow moulding, rotation moulding, thermoforming.

As will be illustrated and discussed below, the presence of the lignin fraction allows the resulting bioplastic material to increase the thermal stability, elastic modulus and tensile strength, while reducing the elongation at break, with respect to the biodegradable biopolymer as such. Moreover, even the optical properties are improved, as being increased the stability at UV-Vis radiation exposure.

Lignin is a class of complex organic polymers that form important structural materials in the support tissues of some algae, vascular plants, included their bark, and herbaceous plants, such as wood (i.e. softwood and hardwood), straw of all cereals, cane bagasse, grass, linen, jute, hemp, or cotton. Lignin can also have mineral source, such as peat, leonardite and coal.

Chemically, in its native form, lignin is a very irregular, randomly cross-linked polymer of phenylpropane units joined by many different linkages, with a weight average molecular weight of 20,000 Daltons or higher. A representative and illustrative lignin fragment (I) containing the most important bonding patterns is shown herein below:

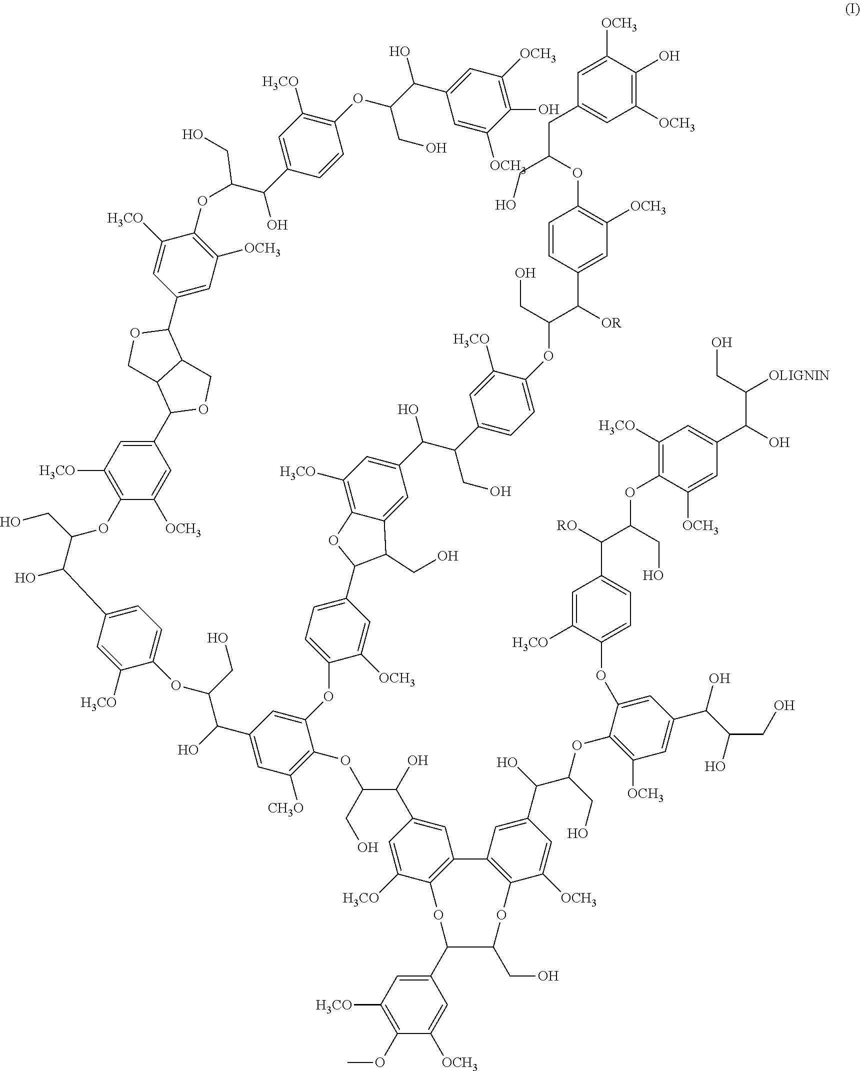

Said polymer is the result of an enzyme-mediated dehydrogenative polymerization of three phenylpropanoid monomer precursors:

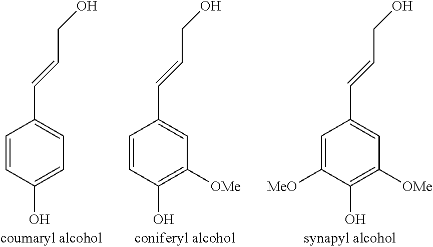 [SMILES: OC/C=C/c1ccc(O)cc1 ; COc1cc(/C=C/CO)ccc1O ; COc1cc(/C=C/CO)cc(OC)c1O]

which result in the following moieties, respectively:

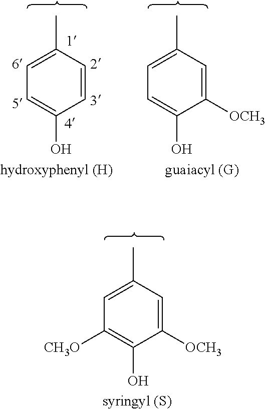

Coniferyl alcohol occurs in all species and is the dominant monomer in conifers (softwoods). Deciduous (hardwood) species contain up to 40% synapyl alcohol units while grasses and agricultural crops may also contain coumaryl alcohol units.

The molecular weight of the three phenylpropanoid monomer precursors varies between 150 Da of coumaryl alcohol, 180 Da of coniferyl alcohol, and 210 Da of synapyl alcohol. The average weight is therefore 180 Da and this value has been used as “phenylpropane unit”. The M_{w} values have been divided by 180 Da, thus obtaining the phenylpropane unit numbers on weight average. As said above, the lignin fraction of the present invention comprises fragments having a weight average molecular weight up to 20,000 Daltons, as measured by Size-Exclusion Chromatography, said fragments comprising up to 111 phenylpropane units on weight average.

Lignin can be categorized to softwood and hardwood lignins according to their raw biomass sources.

Raw biomass sources that can be suitable starting materials for obtaining the relevant lignin fraction are any lignin including essentially pure lignin as well as kraft lignin, biomass originating lignin, lignin from alkaline pulping process, lignin from soda process, lignin from organosolv pulping, lignin from enzymatic processes, lignin from steam explosion processes, and any combination thereof.

By the expression “essentially pure lignin”, it should be understood as at least 80% pure lignin on a dry raw biomass basis, preferably at least 90% pure lignin, more preferably at least 95% pure lignin, the remainder being extractives and carbohydrates such as hemicelluloses as well as inorganic matter.

By the expression “kraft lignin”, it is to be understood lignin that originates from kraft black liquor. Black liquor is an alkaline aqueous solution of lignin residues, hemicellulose, and inorganic chemicals used in a kraft pulping process. The black liquor from the pulping process comprises components originating from different softwood and hardwood species or grass (lignin from sugarcane, or straw) in various proportions. Lignin can be separated from the black liquor by different techniques including e.g. precipitation and filtration. Lignin usually begins precipitating at pH values below 11-12. Different pH values can be used in order to precipitate lignin fractions with different properties. These lignin fractions may differ from each other by molecular weight distribution, e.g. M_{w} and Mₙ, polydispersity, hemicellulose and extractive contents, contents of inorganic material. The precipitated lignin can be purified from inorganic impurities, hemicellulose and wood extractives using acidic washing steps. Further purification can be achieved by filtration.

Alternatively, the lignin is separated from pure biomass. The separation process can begin with liquidizing the biomass with strong alkali followed by a neutralization process. After the alkali treatment, the lignin can be precipitated in a similar manner as presented above.

Preferably, the separation of lignin from biomass comprises a step of enzyme treatment. The enzyme treatment modifies the lignin to be extracted from biomass. Lignin separated from pure biomass is essentially sulphur-free (sulphur content less than 3%) and thus valuable in further processing. Preferably, wood material is pre-treated to remove hemicelluloses and thereafter cellulose has been hydrolysed. The resulting insoluble lignin fraction comprises up to 30 wt % of cellulose.

Preferably, the separated lignin is also subjected to a depolymerization process in order to further reduce the weight average molecular weight of fragments.

In some embodiments, the separated lignin is also subjected to a depolymerization process in order to further reduce the weight and number average molecular weights of fragments.

Suitable depolymerization processes include base-catalyzed depolymerization, acid-catalyzed depolymerization, enzymatic depolymerization, metallic catalyzed depolymerization, ionic liquids-assisted depolymerization, and supercritical fluids-assisted lignin depolymerization.

In preferred embodiments, said lignin fraction is obtained by base-catalyzed depolymerization.

The weight average molecular weight (M_{w}) of fragments in the lignin fraction is measured by Size-Exclusion Chromatography (or ‘SEC’). SEC employs a stagnant liquid present in the pores of beads as the stationary phase, and a flowing liquid as the mobile phase. The mobile phase can therefore flow between the beads and also in and out of the pores in the beads. The separation mechanism is based on the size of the polymer molecules in solution. Bigger molecules will elute first. Small molecules that can enter many pores in the beads take a long time to pass through the column and therefore exit the column slowly. To determine the molecular weights of the components of a polymer sample, a calibration with standard polymers of known weight must be performed. Values from the unknown sample are then compared with the calibration graph. The retention times depend on the used column material, eluent and how similar the used standards are compared to the samples. Preferably, the eluent is preferably 0.1 M NaOH.

Preferably, said lignin fraction comprises fragments having a weight average molecular weight of 2,000-20,000 Daltons. Preferably, said fragments comprise 11-111 phenylpropane units on weight average.

More preferably, said lignin fraction comprises fragments having a weight average molecular weight of 3,000-20,000 Daltons. More preferably, said fragments comprise 16-111 phenylpropane units on weight average.

Even more preferably, said lignin fraction comprises fragments having a weight average molecular weight of 4,000-15,000 Daltons. Even more preferably, said fragments comprise 22-83 phenylpropane units on weight average.

In some preferred embodiments, said lignin fraction comprises fragments having a weight average molecular weight of 4,000-6,000 Daltons. Preferably, in these embodiments, said fragments comprise 22-33 phenylpropane units on weight average.

In other preferred embodiments, said lignin fraction comprises fragments having a weight average molecular weight of 9,000-11,000 Daltons. Preferably, in these embodiments, said fragments comprise 50-61 phenylpropane units on weight average.

In other preferred embodiments, said lignin fraction comprises fragments having a weight average molecular weight of 4,000-9,000 Daltons. Preferably, in these embodiments, said fragments comprise 22-50 phenylpropane units on weight average.

In further embodiments, the lignin fraction has a polydispersity index (PDI) of 1.25 to 12.

The polydispersity index (PDI) or heterogeneity index, or simply dispersity, is a measure of the distribution of molecular mass in a given polymer sample. PDI is the weight average molecular weight (M_{w}) divided by the number average molecular weight (Mₙ). It indicates the distribution of individual molecular masses in a batch of polymers.

As said, the lignin-based bioplastic material of the invention also comprises at least a biodegradable biopolymer is selected from polylactic acid (PLA), polyglycolic acid (PGA), poly(lactic-co-glycolic acid) (PLGA), poly(F-caprolactone) (PCL), poly(butylene succinate) (PBS), poly(γ-glutamic acid) (PGA), polyhydroxyalkanoate (PHA), polyhydroxybutyrate (PHB), poly-3-hydroxyvalerate (PHV), thermoplastic starch (TPS), polybutylene adipate terephthalate (PBAT), starch blend, copolymers and mixtures thereof.

The above biodegradable biopolymers are commercially available products.

For example, Ecovio® from BASF is a certified (EN 17033) soil-biodegradable plastic consisting of the biodegradable copolyester Ecoflex® (polybutylene adipate terephthalate—PBAT) and other biodegradable polymers made from renewable raw materials.

One of the most popular commercial TPS is Mater-Bi®, a family of modified biodegradable and compostable thermoplastic starches produced by Novamont. Mater-Bi® mainly consists of corn starch and various synthetic compounds, including natural plasticizers and hydrophilic substances biologically degradable from synthetic polymers. Depending on Mater-Bi® material composition it presents different properties. Thus, it is possible to find: (i) Mater-Bi® Y, composed starch and cellulose acetate blends, whose properties resemble those of polystyrene (PS); (ii) non-compostable Mater-Bi® A, constituted by a strong complex between TPS and copolymers of polyvinyl alcohol (PVA); (iii) Mater-Bi® V, having a TPS content greater than 85% and a high solubility in water; (iv) Mater-Bi® Z, having a poly(ε-caprolactone) (PCL) matrix; and (v) Mater-Bi® N whose base polymeric matrix is polybutylene adipate-co-terephthalate (PBAT).

Preferred biodegradable biopolymers are polybutylene adipate terephthalate (PBAT), polylactic acid (PLA), poly(butylene succinate) (PBS), polyhydroxyalkanoate (PHA), starch blend, and mixtures thereof.

Preferably, the lignin fraction and the at least a biodegradable biopolymer are in a weight ratio of 5:95 to 95:5, more preferably 20:80 to 80:20.

Preferably, the lignin-based bioplastic material of the invention comprises up to 90 wt % of lignin fraction, based on the material weight.

In preferred embodiments, the lignin-based bioplastic material of the invention further comprises a soil enhancer, said soil enhancer being a carbonate, hydrogen carbonate, phosphate, oxide, or hydroxide, of potassium, sodium, lithium, calcium, magnesium, iron, zinc, copper, urea (ureic), or ammonium, or a mixture thereof.

It has been found that the lignin-based bioplastic material containing both lignin and soil enhancer allows to achieve a number of desirable effects and advantages.

As said, the lignin fraction is highly effective in promoting plant growth as well as in acting against phytopathogens. Additionally, once in soil, part of the lignin fraction is converted into humic acids, which are known to be growth enhancers and soil conditioners conventionally made from fossil deposits found as brown coal or turf. The presence of the soil enhancer allows to improve the soil arability so that the overall efficacy of the lignin fraction is boosted. This means that a significant amount of renewable carbon in soil is increased, thus inducing better structure of soil and enhancing the growth of plants and beneficial fungi.

Moreover, the addition of the soil enhancer is simple and cost-effective, since the respective concentrations are advantageously very low.

Preferably, the soil enhancer is carbonate, or hydrogen carbonate, of potassium, sodium, or ammonium, or a mixture thereof.

In preferred embodiments, the soil enhancer is potassium carbonate.

In preferred embodiments, the lignin-based bioplastic material comprises lignin fraction and at least a soil enhancer in a concentration ratio of 100:1 to 1:100, preferably 50:1 to 1:20, more preferably 20:1 to 1:1.

In preferred embodiments, the lignin-based bioplastic material of the invention further comprises a lignin-degrading microbe, said lignin-degrading microbe being an enzyme, a bacterium, a fungus, a mould, or a mixture thereof.

It has been found that the lignin-based bioplastic material containing both lignin and lignin-degrading microbes allows to achieve a number of desirable effects and advantages. In fact, the additional presence of lignin-degrading microbes converts the remaining part of the lignin fraction into humic acids, which are known to be growth enhancers and soil conditioners conventionally made from fossil deposits found as brown coal or turf. This means that a significant amount of renewable carbon in soil is increased, thus inducing better structure of soil and enhancing the growth of plants and beneficial fungi.

The at least a lignin-degrading microbe is an enzyme, a bacterium, a fungus, a mould, or a mixture thereof. As used herein, “degrade” or “degrading” with respect to lignin indicates that the microbe is able to break-down portions of the chemical structure of the lignin fraction or otherwise acts to reduce the amount (measured by weight, thickness, or other measurable variable) of lignin as compared to a sample not treated with the microbe.

Suitable enzymes are amylase, laccase, cellobiose dehydrogenase, lignin peroxidase, manganese peroxidase, phenol oxidase, laccases, esterase, cellulase (endo- and eso-) glucanase, and glucanase.

Suitable bacteria are Actinomycetes, α-Proteobacteria, γ-Proteobacteria, Azotobacter, Bacillus megatarium, and Serratia marcescens.

Suitable fungi are Phlebia subserialis, Phlebia tremellosa, Dichomitus squalens, Perenniporia medulla-panis, Phlebia brevispora, Hyphodontia setulosa, Ceriporiopsis subvermispora, Phanerochaete chrysosporium, Ceriporiopsis subvermispora, Trametes versicolor, Phlebia radiata, Pleurotus ostreatus, Pleurotus eryngii, Agaricus bisporus (common button mushroom), and Coprinus and Agrocybe species.

Suitable moulds or fungi are Basidiomiceti, Ganoderma, Fomes, Phellinus, Sterenum.

In preferred embodiments, the soil conditioner comprises lignin fraction and at least a lignin-degrading microbe in a concentration ratio of 1000:1 to 10:1, preferably 500:1 to 10:1.

Preferably, the microbe is in a concentration of 1×10⁶ to 8×10⁶ CFU/ml of soil conditioner. More preferably, the microbe is in a concentration of 2×10⁶ to 6×10⁶ CFU/ml of soil conditioner. In preferred embodiments, the microbe is in a concentration of 3×10⁶ to 5×10⁶ CFU/ml of soil conditioner.

In preferred embodiments, the lignin-based bioplastic material of the invention further comprises a fungus of Trichoderma genus, said fungus being selected from Trichoderma species, their protoplast fusants, and mixtures thereof, and wherein the fungus is in a concentration up to 1×10⁷ spores/mg of lignin-based bioplastic material. Preferably, said Trichoderma species is selected from Trichoderma aggressivum, Trichoderma asperellum, Trichoderma atroviride, Trichoderma citrinoviride, Trichoderma cremeum, Trichoderma harzianum, Trichoderma koningii, Trichoderma longibrachiatum, Trichoderma reesei, Trichoderma virens, Trichoderma viride, and Trichoderma viridescens.

A fungus belonging to Trichoderma genus as defined above are able to colonize a variety of niches, antagonize and control plant pathogenic microorganisms and establish a direct beneficial interaction with plants resulting in the enhancement of growth, nutrient uptake and systemic resistance to diseases. In particular, improvement in plant development is generally associated with increased seed germination, root system, plant weight and leaf area, size and/or number of seeds flowers and/or fruits with a consequent increase in yields and often in the content of important nutritional factors. Lignin is known to have an antimicrobial activity against both fungi and bacteria. Therefore, it was expected that treatment of Trichoderma, a well know soil-borne fungus, would result in a direct inhibition at concentrations of lignin found toxic for most of the other fungi already tested. Accordingly, the rational expectation was that Trichoderma would have been affected at lignin concentrations typically considered for use in agriculture application. Surprisingly and unexpectedly, as shown in the Examples below, Trichoderma species listed above were not only unaffected by the lignin fraction at the given concentrations, but even increased their activity in terms of plant productivity as well as in terms of plant growth.

Particularly, it was observed that the effect on plant growth promotion involves an increase in some case up to 25% as compare to single component application.

In addition to what above, it should be appreciated that Trichoderma species and lignin fraction work in different manners and use different mechanisms: this makes the resulting composition effect to be more robust and suitable in a variety of conditions, while reducing the insurgence of resistance mechanisms (for biocontrol).

With the term “protoplast fusants” is meant to include hybrid strains of Trichoderma spp. obtained via protoplast fusion.

Protoplasts are the cells of which cell walls are removed and cytoplasmic membrane is the outermost layer in such cells. Protoplast can be obtained by specific lytic enzymes to remove cell wall. Protoplast fusion is a physical phenomenon, during fusion two or more protoplasts come in contact and adhere with one another either spontaneously or in presence of fusion inducing agents. By protoplast fusion, it is possible to transfer some useful genes from one species to another. Protoplast fusion an important tool in strain improvement for bringing genetic recombinations and developing hybrid strains in filamentous fungi. Said improvement can involve for example higher yields in cellulase production.

Protoplast fusants for the purposes of the present invention can be obtained according to techniques known in the art (e.g. Hassan M M (2014) Influence of protoplast fusion between two Trichoderma spp. on extracellular enzymes production and antagonistic activity, Biotechnology & Biotechnological Equipment, 28:6, 1014-1023)

In preferred embodiments of the composition of the invention, the fungus of Trichoderma genus is selected from T. Harzianum, T. Atroviride and T. virens, and mixtures thereof.

In some embodiments, the composition comprises a mixture of Trichoderma species.

In more preferred embodiments, said fungus is selected from T. Harzianum HK2, T. atroviride HK4 and T. virens GV41, and mixtures thereof, wherein “HK2”, “HK4” and “GV41” are the respective preferred strains.

In some embodiments, the lignin-based bioplastic material comprises a mixture of Trichoderma strains.

When a mixture is present in the lignin-based bioplastic material, each species or strain is at the same or about the same concentration.

In preferred embodiments, the lignin-based bioplastic material comprises two Trichoderma species or two Trichoderma strains in a concentration ratio of 2:1 to 1:2, preferably 1:1.

Preferably, the fungus is in a concentration of 1×10⁶ to 8×10⁶ spores/mg of lignin-based bioplastic material. More preferably, the fungus is in a concentration of 2×10⁶ to 6×10⁶ spores/mg of lignin-based bioplastic material. In preferred embodiments, the fungus is in a concentration of 3×10⁶ to 5×10⁶ spores/mg of lignin-based bioplastic material.

In other preferred embodiments, the lignin-based bioplastic material comprises lignin fraction further comprising up to 30 wt % of cellulose, more preferably 10-30 wt % of cellulose, based on the weight of the lignin fraction, and further comprises at least a cellulose-degrading enzyme, such as exoglucanase (EXG), endoglucanase (EG) and β-glucosidase (BGL). Cellulases are the most efficient enzyme system for the complete hydrolysis of cellulosic substrates into its monomeric glucose, which is a fermentable sugar. As sugar helps plant cellular respiration and cell growth, it follows that the presence of cellulose in the soil conditioner of the invention is advantageous for further improving the overall efficiency in enriching the soil and promoting the plant growth.

In an additional aspect, the lignin-based bioplastic material also comprises agro-chemical additives.

Suitable additives are pH adjusters, acidity adjusters, water hardness adjusters, mineral oils, vegetal oils, fertilizers, leaf manures, and combinations thereof.

Exemplary additives include 2-ethyl hexanol EO-PO, alkoxylated alcohols, alkoxylated fatty amine, alkoxylated triglycerides, alkyl polyglycoside, alkylethersulfate sodium salt, alkylphenolethylene oxide condensate, alkylphenylhydroxypolyoxyethylene, allyl polyethylene glycol methyl ether, amphoteric dipropionate surfactant, di-l-p-menthene, dimethyl polysiloxane, esterified vegetable oil, ethylene oxide condensate, fatty acid esters, fatty alcohol ethylene oxide condensate, fatty alcohol polyalkoxylate, lecithin (soya), methylated rapeseed oil, n-dodecylpyrrolidone, n-methylpyrrolidone, n-octylpyrrolidone, non-ionic surfactant, nonyl phenol ethylene oxide condensate, paraffin oils, poly(vinylpyrrolidione/1-hexadecene, polyacrylamide, polyalkylene glycol, polyalkyleneoxide, polyether modified trisiloxane, polyethylene polypropylene glycol, polyoxyethylene monolaurate, propionic acid, styrene-butadiene co-polymer, synthetic latex, tallow amine ethoxylate, vegetable oil, and mixtures thereof.

The lignin-based bioplastic material of the invention is preferably in a solid form. Said solid form can be tablet, mini-tablet, micro-tablet, granule, micro-granule, pellet, multiparticulate, micronized particulate, or powder.

In a further aspect, the present invention relates to a process for preparing the lignin-based bioplastic material as above described. Said process comprises the steps of:
providing said biodegradable biopolymer and said lignin fraction, and
mixing and grinding them together until a uniform blend is achieved.

In another aspect, the present invention relates to a use of said lignin-based bioplastic material in agriculture.

In an additional aspect, the present invention concerns an item for agriculture at least partially made of the lignin-based bioplastic material, as above described, and having a 2D or 3D shape. As said, the desired shape can be imparted by techniques, such as extrusion, injection moulding, casting, compression moulding, blow moulding, rotation moulding, thermoforming.

Preferably, in the item for agriculture, the lignin-based bioplastic material comprises a lignin fraction comprising fragments having a weight average molecular weight of 4,000-15,000 Daltons, as measured by Size-Exclusion Chromatography, said fragments comprising 22-83 phenylpropane units on weight average.

When the item for agriculture has a 2D shape, said item is for example a mulch film, mulch net, earth retaining net, coating film, film for soil solarization, tape, lace, string, cable tie, band, wrapper, or a combination thereof.

Preferably, said 2D shaped item has a thickness of 5-200 μm.

Preferably, the lignin-based bioplastic material comprises 1-5 wt % of lignin fraction, based on the material weight.

In the case of a mulch film or net, the latter provides an agronomical and environmentally efficient alternative to traditional plastic mulch film, as having the following advantages:
it can be applied with the same machinery,
it controls weeds efficiently, while leading to improved yields and quality of crop, in view of its ability to release nutrients over time and its anti-phytopathogen action,
it does not have to be removed at the end of the season, as it degrades completely into the soil, while leaving no harmful residues, and
it saves time and costs associated with removing and disposal of traditional plastic mulch film.

In the case of a coating film, it can be obtained by spraying a liquid form of the lignin-based bioplastic material, for example, onto the soil surrounding crop, or directly onto seeds, in order to improve their shelf life during storage or their health after sowing.

Said liquid form of the lignin-based bioplastic material can be a solution, suspension, emulsion, dispersion, drops or sprayable fluid, and can be either a water- or oily-based liquid form. Said liquid form can comprise a solvent. Suitable solvents are water, glycols, alcohols, polyalcohols, organic acids, and combinations thereof.

Preferred solvents are water, methanol, ethanol, n-propanol, iso-propanol, n-butanol, isobutanol, allyl alcohol, 1,2-propylene glycol, 1,3-propylene glycol, 1,2-ethylene glycol, polyethylene glycol (PEG), glycerol, lactic acid, polylactic acid, and mixtures thereof. More preferred solvents are water, 1,2-propylene glycol, 1,3-propylene glycol, 1,2-ethylene glycol, polyethylene glycol (PEG), and mixtures thereof.

Preferably, when the lignin-based bioplastic material is in a liquid form, said liquid form has a pH of 5-9, more preferably 6-8.

When the item for agriculture has a 3D shape, said item is for example a container, a tray, a pipe, a dripline, a dripper, a water emitter, a pipe fitting, a nozzle, a hose connector, a water filter, or a combination thereof.

Particularly, when the item is a container, said container can advantageously be a pot, or a multi-pot, such as those for transplanting plants to the ground. In crop cultivation, as well as in gardening, plant sprouts are grown in synthetic plastic pots (e.g. made of PVC, PET, or PE) and then extracted from the latter in order to be transplanted into the ground. The used pots therefore have to be suitably disposed, as the pots could be contaminated by pesticides and other hazardous chemical substances.

On the contrary, a pot or a tray at least partially made of the lignin-based bioplastic material of the invention, does not need to be removed before the transplantation and can be placed directly into the ground together with the plant sprouts. This means that a number of advantages are achieved, such as:
reduced stress to the root system,
reduction of mechanical damage,
easy automation of the transplant operation to open field, and anyway overall time saving,
mechanical protection against parasitic and phytopathogen attacks,
microbiological protection,
water savings,
significant localized release of carbon,
plastic disposal cost savings.

In this regard, containers and trays at least partially made of the lignin-based bioplastic material of the invention can be suitably designed to break in order to facilitate the root development and growth. For example, suitable different thicknesses, breakage lines and openings can be provided on the lateral walls or the bottom surface of containers and trays.

Preferably, the 3D shaped items, such as pots and trays, have a thickness of 0.1-10 mm. When the item is a pipe, or a pipe fitting, or a dripline, similar advantages as those obtained for the 2D items are achieved.

In fact, also irrigation pipes, driplines and fittings are seasonally placed in open field cultivations and then removed and disposed, with time and costs associated to these operations. This is especially true in case of drip irrigation.

Conversely, pipes, driplines and fittings at least partially made of the lignin-based bioplastic material of the invention can be left to degrade after use to give nutrients to the soil, while having an anti-phytopathogen effect.

Moreover, the duration of these items in open field can be regulated by controlling the percentages of the main components.

Preferably, the 3D shaped items, such as pipes and driplines, have a thickness of 50-250 μm.

In preferred embodiments, said item for agriculture can also comprise a UV-blocking agent, so as to add protection against UV radiations.

Indeed, the lignin fraction itself as above described is a UV protecting agent. In fact, it is used in the Examples provided below, instead of benzophenone typically used for PE items. This is one of the main advantages of the instant invention as it allows to achieve a greater resistance to UV radiations of the biopolymers used.

It should be also appreciated that, if the biopolymers above mentioned are used without the lignin fraction as per the current invention, said biopolymers crumbles more quickly when exposed to the sun.

However, as said, one or more additional UV-blocking agents can be used.

Examples of UV-blocking agents may include titanium dioxide, zinc oxide, glyceryl PABA; drometrizole, digaloyl trioleate; 3,(4-methylbenzylidene)camphor; methyl anthranilate; benzophenone-3; benzophenone-4; benzophenone-8; butyl methoxydibenzoylmethane; cinoxate; octocrylene; ethylhexyl dimethyl PABA; ethylhexyl methoxycinnamate; ethylhexyl salicylate; ethylhexyl triazone; p-aminobenzoic acid (PABA); 2-phenylbenzimidazole-5-sulfonic acid; homosalate; isoamyl-p-methoxycinnamate; bis-ethylhexyloxyphenol methoxyphenyl triazone; disodium phenyl dibenzimidazole tetrasulfonate; drometrizole trisiloxane; diethylhexyl butamido triazone (Diethylhexyl butamido triazone); polysilicone-15 or dimethicodiethyl benzal malonate; methylene bis-benzotriazolyl tetramethylbutylphenol; terephthalylidene dicamphor sulfonic acid and diethylamino hydroxybenzoyl hexyl benzoate.

The degradation rate over time of the lignin-based bioplastic material of the invention can be modulated also by adding suitable ingredients having a high rate of water-solubilization and/or degradation, such as gelatinized starch, amino acids, peptides, sugars, oligosaccharides, carragenins, and/or by adding a suitable amount of a lignin-degrading microbe, as described above.

The properties of degradation over time are important in particular for driplines.

In fact, the gathering of driplines at the end of their use, as well as their disposal, represents a significant cost of the whole application. In this regard, it should be appreciated that, owing to the nature of the lignin-based bioplastic material of the invention, it is possible to inject into the driplines, after the last irrigation, a water-based disaggregating/degradating solution, preferably designed to act on the more abundant component of the material.

In practise, a low volume of a concentrated solution is introduced into the driplines (just enough to fill all the lines), and left to act until the driplines are disaggregated/dissolved into the soil, thus conveniently avoiding the steps of gathering and disposing the driplines at the end of their use.

Suitable water-based disaggregating/degradating solutions are solutions of phosphoric acid (which is also a fertilizer) or alkaline or enzymatic or inoculated solutions of composting-bacteria pools.

The item for agriculture at least partially made of the lignin-based bioplastic material of the invention can also comprise further components, such as additional fertilizers, and plant growth promoters.

It should be also understood that all the combinations of preferred aspects of the lignin-based bioplastic material of the invention, as well as of the preparation processes, and uses of the same, as above reported, are to be deemed as hereby disclosed.

All combinations of the preferred aspects of the lignin-based bioplastic material of the invention, preparation processes, and uses disclosed above are to be understood as herein described.

Below are working examples of the present invention provided for illustrative purposes.

### EXAMPLES

M_{w} and Mₙ in these Examples have been measured by Size-Exclusion Chromatography according to the following procedure.

“wt %” means weight percentage based on the weight of the organic-inorganic hybrid material, unless otherwise specified.

Reagents and Materials
Eluent: 0.1 M NaOH, flow 0.5 ml/min
Calibration for RI detector: Pullulan standards, Mₚ: 100,000-1,080 (six standards), where Mₚ is peak maximum molecular weight
Calibration for UV-detector (280 nm): PSS standards, polystyrenesulfonate sodium salt, Mₚ 65,400-891 (six standards). Standards are dissolved into ultra-pure water, concentration should be approximately 5 mg/ml. Injection volume is 20 μl.
Quality control samples: lignin with known M_{w} distribution is used.

Equipment and Instruments
Dionex Ultimate 3000 Autosampler, column compartment, and pump
Dionex Ultimate 3000 Diode Array Detector
Reflective Index detector: Shodex RI-101
Columns: PSS MCX columns: precolumn and two analytical columns: 1000 Å and 100 000 Å, column material is sulfonated divinylbenzen copolymer matrix.
Syringe filters 0.45 μm and glass sample bottles for STD samples. Sample filtration: Mini-Uniprep syringeless filter device PTFE or Nylon, 0.45 μm. For prefiltration 5 μm syringe filter if needed.
Measuring bottles

Procedure
Preparation of the eluent

Ideally, water used to prepare eluents should be high quality deionized water of low resistivity (18 MΩ·cm or better) that contains as little dissolved carbon dioxide as possible. The water must be free of biological contamination (e.g., bacteria and molds) and particulate matter.
Needle washing with 10% MeOH-water
Liquid samples

Strong alkaline liquor samples are diluted 1:100 and filtered with PTFE syringe filters (0.45 μm) to vials. Solid lignin samples are diluted and dissolved into 0.1 M NaOH and filtered with PTFE, 0.45 μm syringe filters. Ready samples are load into autosampler. Injection volume is 20 μl. After samples 1 M NaOH is injected as a sample to clean the column.

Instrument parameters:
Flow rate 0.5 ml/min
Eluent 0.1 M NaOH
Column oven temperature 30° C.
Isocratic run
Run time 48 minutes
Solid samples

Solid samples (lignin) are dried overnight in an oven at 60° C., if needed. Approximately 10 mg is weighed into a 10-ml measuring bottle. Sample is dissolved and diluted into 0.1 M NaOH solution and filled into a mark. Sample is filtered with PTFE, 0.45 μm filters. If sample does not dissolve properly, it can be put in a ultrasound water bath or sample can be filtered through a 5 μm syringe filter.
Standard samples for calibration

Approximately 50 mg of each standard is weighed into a 10-ml measuring bottle and ultrapure water is added and filled into a mark. Standards are filtered with PTFE 0.45 μm syringe filters. After running the calibration samples, calibration results are integrated and processed in the processing method and saved. Calibration is linear 1st order calibration.
Quality control samples

For lignin samples, lignin with known M_{w} distribution is used as a quality control sample. Lignin is dissolved into 0.1 M NaOH and the concentration is approximately 1 mg/ml.

### Example 1

Beech wood (Fagus sylvatica) was subjected to an alkaline and enzymatic hydrolysis, whereby lignin fraction free from hemicelluloses and cellulose was obtained. Lignin fraction thus separated from pure biomass has the following characteristics:
>95% of total solids
Single Species: Beech wood
M_{w} 9,000-11,000 Da (50-61 phenylpropane units)
essentially sulphur-free (sulphur content less than 3%)
comprises 23-29 wt % of cellulose.

This solid lignin fraction is shortly referred to as “Beech”.

### Example 2

The following lignin fraction has been extracted from Kraft black liquor, said lignin fraction having the following characteristics:
>95% of total solids
Single Species: Southern Pine
M_{w} 4400-5000 Da (24-28 phenylpropane units)
Mₙ 1200-1300 Da (6-7 phenylpropane units)
Structures of OH-groups:

| | |
|---|---|
| aliphatic | 2.1 mmol/g |
| carboxylic | 0.5 mmol/g |
| condensated and syringyl | 1.7 mmol/g |
| guaiacyl | 2.0 mmol/g |
| catecholic and p-OH-phenyl | 4.0 mmol/g |

This solid lignin fraction is shortly referred to as “OXO”.

### Example 3

Development of a Dripline Made of the Lignin-Based Bioplastic Material of the Invention

The first phase of this study involved the initial screening of the most important parameters to determine the optimal composition of the mixture and the thickness that the tubular should have for subsequent field tests. For this purpose, mixtures of a commercial biodegradable resin with variable concentrations of lignin were prepared and subsequently these mixtures were used to prepare tubulars with different thicknesses. Finally, the latter were filled with water, sealed and exposed to environmental weather conditions to verify their chemical-physical stability over time. The degradation of the tubulars was followed by mechanical traction analysis for the entire duration of natural aging with tests carried out every three weeks. Finally, the thermo-gravimetric analysis on the non-aged mixtures provided information regarding their thermal degradation, while the diffuse reflectance analysis of the films produced useful information on the optical properties of the mixtures used.

Materials and Methods

The biodegradable bio-resin (or biopolymer) selected for this study was Ecovio® M2351 from Basf, which is based on biodegradable copolyester Ecoflex® F Blend and polylactic acid (PLA), while the lignin fraction used was a commercially available lignin according to Example 2 (and marketed as Oxilem™ by Green Innovation GmbH).

The mechanical tensile tests were carried out according to the ISO 527-3 standard. The thermo-gravimetric analyzes were performed in the temperature range of 30-500° C. with a scanning speed of 10° C./min. The water used for the tests was running water from an aqueduct with a pH of 7.3. The tubes for the aging tests were made as follows: initially a mixture of resin with a percentage of lignin of 30%, called masterbatch, was prepared and extruded in the form of pellets. Subsequently, the masterbatch was mixed with the resin in the appropriate quantities to obtain mixtures with the desired concentrations of lignin. The latter were transformed into thin sheets with a width of about 90 mm and variable thickness by means of cast extrusion. Using the samples thus obtained (with variable thickness and concentration of lignin), tubulars were made, using a pair of overlapping and heat-welded sheets on three of the four sides. Finally, each tubular was filled with water and sealed to prevent evaporation during natural aging. The concentrations of lignin used were four, i.e. 0%, 2.5%, 5% and 10%, while the thicknesses made were two, i.e. 100 and 200 microns, for a total of 8 different samples. Five mechanical tests were planned, each every 3 weeks of aging, then a total of 40 tubulars were prepared and exposed. The aging tests were performed in the summer season, when global solar radiation and temperatures reach their maximum values.

Results

Thermal Analysis

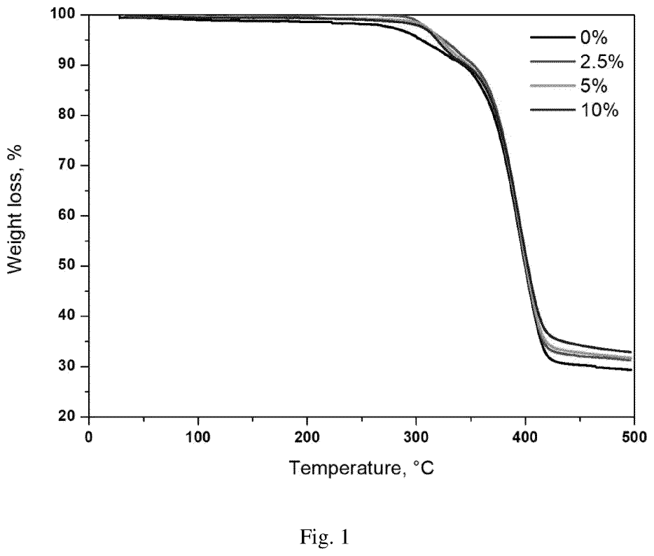

The first test performed concerned the chemical-physical stability of the mixtures by means of thermo-gravimetric analysis, the results of which are shown in FIG. 1. The thermo-degradation of the resin takes place in two separate phases, in the temperature range between about 265 and 450° C. Without going into the details of its mechanisms which are beyond the scope of this analysis, the relevant data is that the onset of thermo-degradation shifts to higher temperatures with the introduction of lignin fraction. In particular, it is estimated that the temperature increase ranges from 265° C. to 285° C. with 2.5% and about 295/300° C. with concentrations of 5 and 10% respectively. This result indicates that the thermal stability of the resin is increased with the addition of lignin fraction up to a concentration of 5%. A further increase in the latter does not produce appreciable variations.

Mechanical Analysis

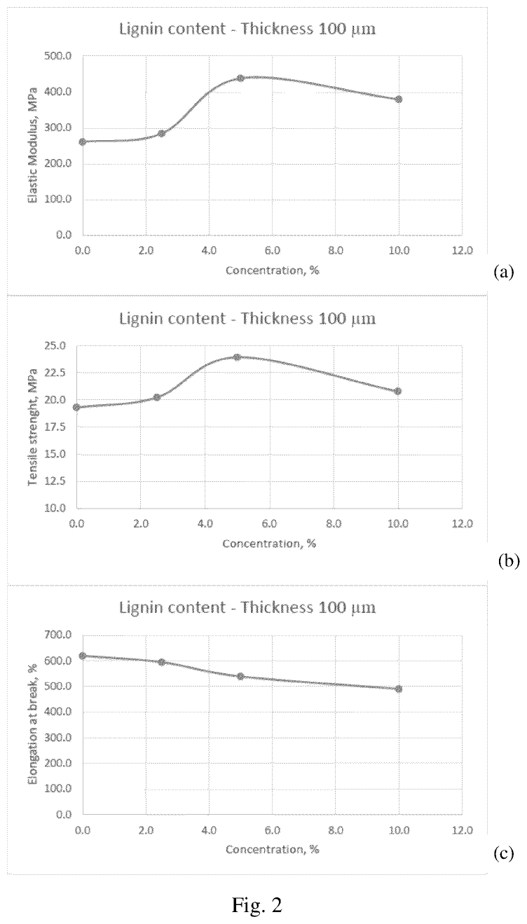

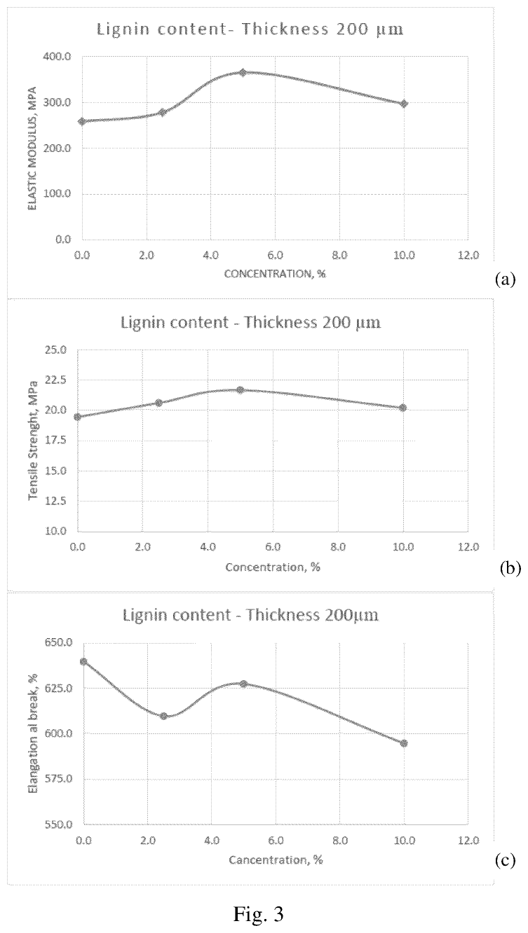

The mechanical analysis carried out on the resin and its mixtures with lignin fraction was conducted in tensile geometry, parallel to the direction of extrusion and at room temperature. The main mechanical parameters of the tests, before aging, are shown in FIGS. 2a-c and FIGS. 3a-c: it is evident that the addition of lignin fraction involves an increase in the rigidity of the mixtures for all the concentrations used (increase in the Elastic Modulus and Tensile Strength, reduction of the Elongation at Break). In general, the introduction of low molecular weight particles into a polymer matrix produces a plasticising effect as it increases the free volume between the macromolecules and reduces intra- and inter-polymeric interactions. In this case, however, during the extrusion process, the plasticizing effect due to the presence of lignin fraction particles produces a higher orientation of the resin macromolecules which is reflected in an increase in the stiffness of the mixtures along the direction of extrusion. Another result to underline is that the 5% concentration of lignin fraction produces the maximum system stiffening effect. In fact, a further increase in lignin is reflected in a reduction in mechanical properties.

Optical Properties

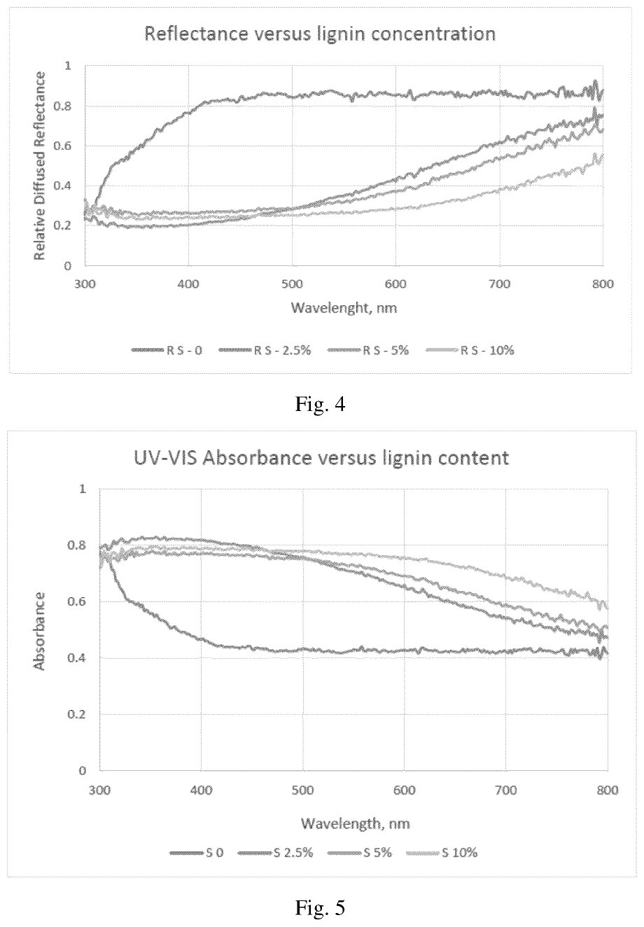

The optical properties were obtained from diffuse reflectance measurements on films with variable lignin fraction concentration. The use of this technique was necessary due to the solid and colored nature of the films and consists in measuring the radiation reflected in all directions by the sample surface. From this information, the amount of radiation absorbed by the surface itself can be traced (FIGS. 4 and 5).

As can be seen from FIG. 4, the spectrum of the resin without additives shows a good reflection capacity of the wavelengths in the ultraviolet region (UV, 300-400 nm) and a high reflection of the visible radiation (400-780 nm), as predictable from its white color. On the contrary, the introduction of lignin fraction into the resin produces a surface with poor reflection in the UV region and in the blue and green regions of the visible spectrum (400-600 nm). The reflection begins to be significant only in the spectral region of red, as evident from the coloring of the films. Furthermore, the increase in the concentration of lignin fraction produces an increase in the reflected radiation in the same red region corresponding to an increase in the coloring of the films. From these spectra, the corresponding absorption spectra of the light radiation shown in FIG. 5 are obtained. From this figure, it is possible to clearly observe the property of the lignin fraction to absorb a considerable amount of UV radiation compared to the resin without additives, thus indicating the suitability of the lignin fraction as a UV stabilizer of the resin itself. Finally, the increase in the lignin fraction concentration above 2.5% does not give rise to greater absorption in the ultraviolet region, thus indicating this concentration as a limit value such as to produce a “saturation” effect.

Aging Test

In this test, the behavior of the various mixtures during exposure to environmental meteorological conditions and in continuous contact with water was investigated, in order to identify which composition, in terms of lignin fraction content and thickness, can guarantee a sufficient operating time for the future application. For this reason, the tubulars filled with water were subjected to natural aging in the summer months (i.e. from mid-June to the end of September), when the environmental conditions are severe. Aging was followed by measuring the elongation at break of the samples every three weeks, by means of mechanical tensile analysis.

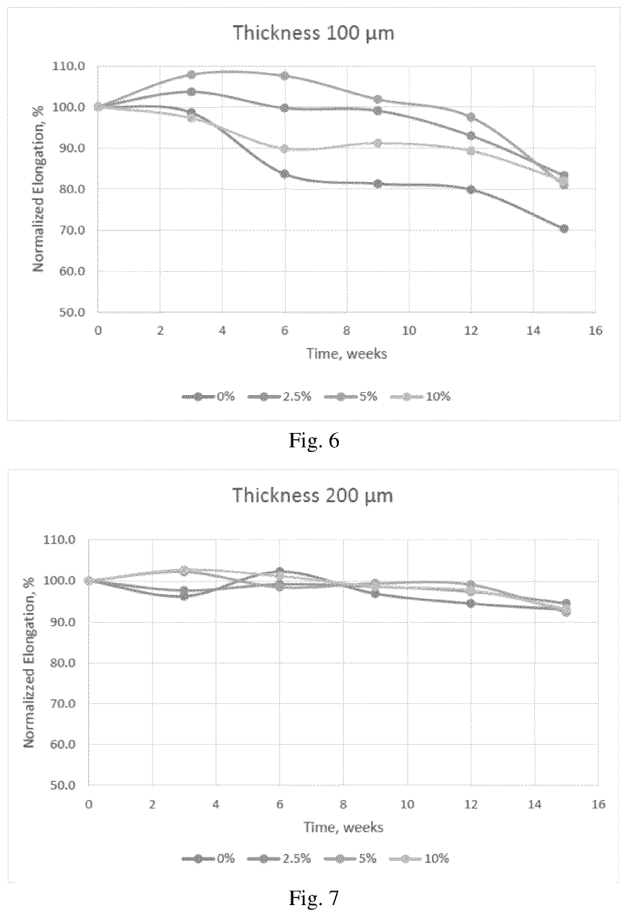

Test results are shown in FIGS. 6 and 7 for the 100 and 200 μm thick samples, respectively. The Figures show the percentage reduction in elongation at break compared to its initial value as a function of the aging time. In this representation, when a material reaches the threshold value of 50%, it is considered mechanically degraded.

As for the samples with a thickness of 100 μm, the one without additives begins to lose a substantial part of its mechanical properties indicating a certain degree of degradation. While the samples containing lignin fraction still show good mechanical properties, suggesting only the beginning of their degradation. A different behavior, however, is shown by samples with a thickness of 200 μm. Indeed, after 15 weeks of aging all the samples still retain their initial mechanical properties, indicating that degradation has not yet started.

### CONCLUSIONS

From the results obtained on unaged samples, it is clear that the addition of lignin fraction produces different effects in the host resin that can be summarized as follows:
increased thermal stability,
improvement of mechanical properties through an increase in the elastic modulus and the tensile strength in the direction of extrusion of the materials,
increased UV stabilization through the absorption capacity of ultraviolet radiation by the lignin fraction.

The same results indicate that the introduction of lignin fraction produces the benefits listed for concentrations between 2.5 and 5%.

The natural aging tests, performed over a period of time of 15 weeks, confirmed the properties of lignin fraction as a stabilizer against UV and thermal degradation of the resin used. Furthermore, the simultaneous contact of the samples with water during these tests further strengthens this finding.

The results obtained, therefore, support that the mixtures of biodegradable biopolymer and lignin fraction can be used for manufacturing biodegradable items for agricultures, such as tubulars, pipes, driplines, and related connectors and accessories. Preferably, these items may contain amounts of lignin fraction of 2.5% of 5%, as higher concentrations would not give further benefits. Furthermore, the thickness of the driplines should be better higher than 150 microns, in order to fulfill the typical requested times of duration in open field.

1. An item for agriculture at least partially made of a lignin-based bioplastic material and having a 2D or 3D shape, said lignin-based bioplastic material comprising a lignin fraction and at least a biodegradable biopolymer, wherein:
said lignin fraction comprises fragments having a weight average molecular weight of 4,000-15,000 Daltons, as measured by Size-Exclusion Chromatography, said fragments comprising 22-83 phenylpropane units on weight average, and
said at least a biodegradable biopolymer is selected from polylactic acid (PLA), polyglycolic acid (PGA), poly(lactic-co-glycolic acid) (PLGA), poly(ε-caprolactone) (PCL), poly(butylene succinate) (PBS), poly(γ-glutamic acid) (PGA), polyhydroxyalkanoate (PHA), polyhydroxybutyrate (PHB), poly-3-hydroxyvalerate (PHV), thermoplastic starch (TPS), polybutylene adipate terephthalate (PBAT), starch blend, copolymers and mixtures thereof.

2. The item for agriculture of claim 1, wherein said at least a biodegradable biopolymer is selected from polybutylene adipate terephthalate (PBAT), polylactic acid (PLA), poly(butylene succinate) (PBS), polyhydroxyalkanoate (PHA), starch blend, and mixtures thereof.

3. The item for agriculture of claim 1, wherein, in the lignin-based bioplastic material, the lignin fraction and the at least a biodegradable biopolymer are in a weight ratio of 5:95 to 95:5, more preferably 20:80 to 80:20.

4. The item for agriculture of claim 1, wherein the lignin-based bioplastic material comprises up to 90 wt % of lignin fraction, based on the material weight.

5. The item for agriculture of claim 1, said lignin fraction having a polydispersity index (PDI) of 1.25 to 12.

6. The item for agriculture of claim 5, wherein said lignin fraction comprises fragments having a weight average molecular weight of 4,000-6,000 Daltons or 9,000-11,000 Daltons.

7. The item for agriculture of claim 1, comprising a lignin fraction further comprising up to 30 wt % of cellulose, preferably 10-30 wt % of cellulose, based on the weight of the lignin fraction, and further comprising at least a cellulose-degrading enzyme, such as exoglucanase (EXG), endoglucanase (EG) and β-glucosidase (BGL).

8. The item for agriculture of claim 1, wherein the lignin-based bioplastic material further comprises a soil enhancer, said soil enhancer being a carbonate, hydrogen carbonate, oxide, or hydroxide, of potassium, sodium, lithium, calcium, magnesium, iron, zinc, copper, or ammonium, or a mixture thereof.

9. The item for agriculture of claim 1, wherein the lignin-based bioplastic material further comprises a lignin-degrading microbe, said lignin-degrading microbe being an enzyme, a bacterium, a fungus, a mould, or a mixture thereof.

10. The item for agriculture of claim 1, wherein the lignin-based bioplastic material further comprises a fungus of Trichoderma genus, said fungus being selected from Trichoderma species, their protoplast fusants, and mixtures thereof, and wherein the fungus is in a concentration up to 1×10⁷ spores/mg of lignin-based bioplastic material.

11. The item for agriculture of claim 1, having a 2D shape, said item being a mulch film, mulch net, earth retaining net, coating film, film for soil solarization, tape, lace, string, cable tie, band, wrapper, or a combination thereof.

12. The item for agriculture of claim 11, wherein said 2D shaped item has a thickness of 5-200 μm.

13. The item for agriculture of claim 1, having a 3D shape, said item being a container, a tray, a pipe, a dripline, a dripper, a water emitter, a pipe fitting, a nozzle, a hose connector, a water filter, or a combination thereof.

14. The item for agriculture of claim 11, wherein said 3D shaped item has a thickness of 0.1-10 mm.

15. The item for agriculture of claim 1, having a rate of water-solubilization and/or degradation that over time is modulated by:
adding suitable ingredients to the lignin-based bioplastic material, such as gelatinized starch, amino acids, peptides, sugars, oligosaccharides, carragenins, and/or a lignin-degrading microbe, and/or
adding a water-based disaggregating/degradating solution, such as a solution of phosphoric acid or alkaline or enzymatic or inoculated solution of composting-bacteria pools, at the end of the application.
